(19) United States
(12) Patent Application Publication
(10) Pub. No.: US 2016/0055601 A1
(43) Pub. Date: Feb. 25, 2016

(54) Seller and Agent Collaboration System

(71) Applicant: Alex Levy, Englewood, CO (US)

(72) Inventor: Alex Levy, Englewood, CO (US)

(21) Appl. No.: 14/467,024

(22) Filed: Aug. 24, 2014

(51) Int. Cl. G06Q 50/16; G06Q 30/06

(52) U.S. Cl. CPC G06Q 50/16; G06Q 30/06

(57) ABSTRACT

A seller and agent collaboration system and method for matching a seller with an agent to help consummate a sale of real property is disclosed, wherein the system includes credential protected seller and agent data portals, wherein the seller and the agent input values for a plurality of agent criterion parameters that are matched based on an importance weight and the closeness of the seller and agent input values, with the output resulting in an agent being matched with a seller and also with lesser matched agents being listed to the seller. Subsequent to this the seller can initiate a one-way conversation with an agent anonymously so that the seller remains in control of the conversation until the seller decides to engage in a full disclosure with their agent of choice.

### FIELD OF THE INVENTION

The present invention generally relates to internet based matching of a seller of an asset with an agent for marketing the asset and consummating the asset sale for the seller. More particularly, the present invention presents a system and method of matching a seller of real estate to a real estate agent for marketing and completing the sale of the real estate, wherein a plurality of conditions exist for building a formation of the seller and agent relationship to create an optimum fit as between the seller and agent

### DESCRIPTION OF THE RELATED ART

From a seller's perspective it is desirable to significantly narrow the number of agents that could be contracted with and for the seller to be in control of the situation such that the seller ultimately selects the best potential agents to communicate with before finally the seller then selects the single agent that they want to use. One of the goals of the present invention is to prevent unmitigated solicitation of the seller by multiple agents that may not be a good fit with the seller's desires. From the agents perspective it is to only spend preliminary time with seller's who are already highly motivated to potentially contract with an agent, thus making the matching process as between seller and agent a better and more efficient experience for both. There is a considerable challenge in ascertaining authenticity of each party being the seller and the agent prior to the seller making the first contact to the group of potentially desirable agents due to the inherent anonymous nature of the internet with either party having the ability to generate a virtual online profile that is deceptive, misrepresentative, and fraudulent, this is termed the “online disinhibition effect” which can result in the complete abandonment of social restrictions and inhibitions that would otherwise be present in a normal face to face interaction.

Thus as the antithesis to this, wherein the old computer industry printer term of “WYSIWYG” would apply in face to face human interactions meaning “what you see is what you get”, i.e. minimal deception that would be expected from say the seller evaluating an agents qualifications or on the other hand the agent evaluating the seller's representations concerning the property to be sold if they were to meet initially face to face physically at the real property. Of course initial face to face meetings as between the seller and agent would comport with “WYSIWYG”, however, it would be inefficient as the internet can be made to do the initial “culling” of potential good fit seller and agent relationships as long as the problem of the “online disinhibition effect” can be taken care of or at least substantially minimized.

In the online world, “WYSIWYG” can be disturbingly far from the truth as what you see virtually online for a person's or entities profile can be far removed from what you get face to face. Part of this “online disinhibition effect” is due to the individual who creates the online profile from having any meaningful reprisal or liability for their deceptive or misrepresentative representations of who or what they are, this being compounded by the anonymous nature of the internet with many individuals using an alias as an online name, wherein this particular individual essentially becomes another person when interacting face to face with another, i.e. by essentially being who they really are.

This problem with the internet in deceptive representations by one individual to another has a number of causes starting firstly with the individuals not actually knowing one another, plus potentially being in other cities, states, and countries has the effect of providing an insulating layer of distance protection that can lead to even antisocial or harmful behaviors. Secondly, the virtual nature of the internet allows a deceptive individual to put in their profile misrepresentative text, images, and videos, this combined with the total lack of reading the things that indicate an individual's true live in person nature such as; “body english”, also eye movement, and voice inflection of another also due to the virtual nature of the internet are lacking, wherein in a face to face interaction as between individuals, clues can be picked up from seeing someone in a “live” situation as opposed to the non-live virtual indicators of text, images, and video.

Thirdly, in the online context, communication does not typically happen in “real time” i.e. being in an asynchronous nature, this leads to impulsive items posted online quickly without much real thought and a reply given to the impulsive items that could be carefully considered with much time for thought, thus making the communication context disjointed and inefficient as between two individuals. Fourth, without face to face cues as to a party's intent in an online context, it is human nature to assign characteristics to the other party as images that are imputed by imagination solely based upon the virtual online text, images, and video from the other party. Unfortunately these characteristics assigned to the other virtual party are based upon the reading party's own mindset which can be completely incorrect as exists in that party's mind (thus in effect creating a reality that has gaps filled with imagination) of the party who is reading the online profile, again being a poor communication model.

Fifth, as the online context can be without consequences, it can seem to be just a game to the party creating the virtual online profile, thus the grounding rules (being authentic, real, factual, and the like) that would exist in a face to face interaction don't apply online, i.e. so what if I stretch the truth a little-what could happen-can be the prevailing attitude. Sixth, it is not really known who created the online virtual profile, i.e. who really is the person who created the virtual online profile which would have a significant effect in a face to face context, however, in the online world, who the online profile creator is, is not really relevant whereas the content of the text, images, and video are what matters online. Thus various levels of authority have no meaning online-thus leading to impulsive and undesirable behavior.

Further, this undesirable behavior seemingly has no victims, i.e. the trouble that an online profile creator can bring forth from misrepresentations, fraud, harassment, and the like seemingly has invisible victims-in going with the previously stated lack of consequences for aberrant online behavior. Seventh, in an online context-the ability to disseminate information to a very large group of people is unprecedented, before the advent of the internet being available to millions of people, is was quite costly to disseminate information on a broad scale, i.e. requiring large expenses on traditional media such as radio, newspapers, magazines, TV, and the like, thus with the internet's ability to disseminate information to millions of people at practically no cost-can mean that the harm from undesirable behaviors can be of a large magnitude.

In summary, these undesirable online behaviors that are rooted in the seven categories discussed above are manifested in cyber bullying, article, image, and video comment sections that are filled with outrageous statements, politics, racism, and threats, plus phishing emails with computer viruses, goods/services review fraud, flaming sites, trolls, baiters, and the like, all due to the anonymity of the internet. This has over the fifteen years or so of widespread public use of the internet lead to a lack of trust of what is published online, such that the saying could be-“you can't hardly believe anything that is on the internet these days” which causes a real reputation problem with internet use, especially in a business context.

This is the crux of the present invention, in enabling a system that can help ensure authenticity, accuracy, and trust in an online context. This of course is a widely recognized problem, however, being of more or less important depending upon the business use of the internet, if for instance I am an online seller of goods, it is somewhat simpler in that if I deliver what I say I am and charge the proper amount, i.e. all under the control of the online seller, then I as the online seller can establish trust. However, in another scenario such as a dating site, wherein millions of individuals put up their profiles and interact with other individuals the prevalence of fraud and misrepresentation is widespread as there is little if any control present, a like scenario for a site that would bring together previously unknown individuals (like a dating site) for the purpose of doing business, wherein the question is basically “WYSIWYG” is what I am seeing, what I am getting from this online profile, because without trust and authenticity a business collaboration site will quickly acquire a bad reputation and most likely fail.

In spite of the internet's lack of trust and authenticity the online market place continues to become more predominant player in the goods and services commerce area, wherein it is estimated 93% of all purchase decisions originate with an on-line search, so making the internet work better for trust and authenticity is of paramount importance and cannot be ignored, especially in the business context. The prior art in this area touches on this concept of previously discussed internet anonymity problems in a piecemeal way, of which a summary is given below.

In looking at the prior art, starting with U.S. Pat. No. 5,664,115 to Fraser disclosed a method and apparatus of automatically matching sellers of property with potential buyers through a communications network (preferably the Internet) in which a host system communicates with the sellers and the potential buyers over telephone or dedicated data transmission lines. The host system in Fraser obtains and stores a first set of records each corresponding to a property to be sold, that are the typical data of name, address, contact information, property specifics, see FIGS. 4A, 4B, and 4C for an example, and some degree of seller authentication by verifying seller property records, see FIGS. 6A, 6B, and 7.

In Fraser, the first set of property records can be searched by a remote data terminal associated with a potential buyer, wherein the results of this search are then provided to the potential buyer, who indicates specific property listings that the potential buyer may be interested in purchasing. The potential buyer in Fraser provides identifying information which is then provided to the sellers of the indicated property. In Fraser, provisions are made to ensure that the sellers, who list property support the system financially, see FIG. 5A. As a filtering qualification in Fraser to protect the sellers from multiple unqualified buyers, there is a buyer screening criteria that tries to ensure that the potential buyers are ready, able, and willing to make a particular property purchase, i.e. to actually consummate the sales transaction, see FIG. 5B, further see column 9, lines 27 to 44. Also in Fraser, it is desirable to preserve a seller's identification, i.e. to remain anonymous, thus allowing the seller to review a list of potential buyers qualifications prior to the seller contacting a particular buyer, see FIGS. 8B and 9, also column 7, lines 11 to 19. Further, the system in Fraser permits automatic evaluation of potential buyers, basically being just a financial ability to afford the particular property, see column 6, lines 49 to 67, to be able to screen buyers whose information does not match minimum criteria provided by the seller.

Continuing in the prior art in U.S. Pat. No. 8,078,698 to Moore, disclosed is a method of producing demographic data from real property data and then inferring from the property data additional demographic traits. Moore includes; a virtual host, comprising: generating the virtual host; obtaining a physical address associated with an internet protocol address of a user interacting with the virtual host; obtaining property records associated with the physical address; inspecting the property records for a date of transfer; comparing the date of transfer to a current date to determine a term of ownership. Also, Moore infers an age of the property owner from the term of ownership; and endowing the virtual host with other demographic traits associated with the age of the property owner and the value and location of the property to infer income of the property owner, also items like keystroke speed for also inferring age of the property owner.

Next, in the prior art looking at U.S. Pat. Nos. RE43,068 & 6,973,432 to Woodard, et al., disclosed is a process for managing the calendar showing and usage of real estate up for sale. The process in Woodard allows buyers to schedule a showing or in person viewing of real estate directly through an Internet web site. The buyer in Woodard will be able to view the schedule of multiple properties in their area giving them the ability to plan their house hunting expeditions. Further in Woodard, sellers of real estate may block out times when they do not want their property shown directly from their own computers. Agents in Woodard will have complete visibility of the seller's availability time thereby increasing availability to schedule and sellers will also be able to view when agents have scheduled a showing for their property and gain access to historical records of their property showings. Agents in Woodard will be able to list properties for showings and make appointments for their clients to view other agents' properties with a click of a mouse. The central scheduling focus in Woodard will be around the property as the seller's agent along with the seller will set up pre-conditions allowing a buyer or buyer's agent to select times for showings around these pre-conditions.

Continuing, in the prior art in U.S. Pat. No. 6,735,570 to Lacy, et al., disclosed is an improved administration system for use in managing and reporting skill assessment data entered by users of a skill assessment tool. The skill assessment tool of Lacy has the preferred embodiment that includes a large skill set of possibly-unrelated skills, wherein a large, diverse use population may employ the skill assessment tool to enter data rating a user's proficiency at performing ones of the skills in the skill set. In Lacy, the resulting skill assessment data may therefore be both extensive and diverse. The administration system in Lacy allows the skill assessment data to be reported using any selectable subset of the users or any selectable subset of the skills supported by the skill assessment tool.

Further, in the prior art in U.S. Pat. No. 8,473,320 to Judy disclosed is a method and system for measuring transferability of workers between and among occupations by means of the mathematical relationships between those occupations' key attributes, as defined by publicly available data on the competencies required as specified by a complete catalog of U.S. occupations known as O*NET. This method in Judy provides a concise, informative measurement for comparing the relative requirements of Abilities, Skills, Knowledge, and other relevant attributes of occupations, enabling users to gauge the feasibility of transferring workers from one occupation to another through the generation of a correlation coefficient on the transferability of workers between different occupations.

What is needed is a seller and agent collaboration system for matching a seller with an agent to help consummate a sale of real property, wherein the system includes credential protected seller and agent data portals, the seller and the agent input values for a plurality of agent criterion parameters that are matched based on an importance weight and the closeness of the seller and agent input values, with the output resulting in an agent being matched with a seller and also with lesser matched agents being listed to the seller. Subsequent to this the seller can initiate a one-way conversation with an agent anonymously so that the seller remains in control of the conversation until the seller decides to engage in a full disclosure with their agent of choice.

### SUMMARY OF INVENTION

Broadly, the present invention is of a seller and agent collaboration system for matching a seller with an agent to help consummate a sale of real property, wherein the system includes a credential protected seller data portal for a single seller to gain access to a seller section and a single seller profile database account created with a non-anonymous seller identification and an anonymous seller identification. The seller profile database account includes an agent criterion that has a plurality of agent parameters, wherein the seller inputs a unique scale item level for each of the plurality of agent parameters in addition to the seller inputting a unique seller selected weight associated with each agent parameter. Further included is a credential protected agent data portal for a single agent to gain access to an agent section and a plurality of single agent database accounts defined as an agent pool. Each single agent profile database account is created with a non-anonymous agent identification; the agent profile database account includes an agent criterion that has a plurality of agent parameters, wherein the agent inputs an index value for each of the plurality of agent parameters in addition to the agent inputting a unique agent selected weight associated with each agent parameter.

In addition, there are instructions for producing a matching algorithm as between the seller profile database account and the agent pool being the plurality of single agent database accounts, the matching algorithm has a priority rank ordering of the seller selected weights associated with each agent parameter that are matched with each of the plurality of unique agent selected weights associated with each agent parameter such that the seller selected parameter weights and the agent selected parameter weights are equally matched in a pair, irrelevant to a particular agent criterion parameter of the seller or the agent. Further, for each the equal weighted pair if the equal weighted pair has identical parameters then a match is sought as between the sellers scale item level and the agent's index value, termed a first category level range, if no match exists then based upon the sellers parameter, a same parameter adjacent scale item level is checked for a match termed a second category level range.

Further, if no match is found, then based upon the sellers parameter, a same parameter next adjacent scale item level is checked for a match termed a third category level range, if no match exists or the equal weight sellers and agent parameters are not the same, iterative instructions are such that sellers next highest weight parameter scale item level is matched to the agent pool to a specific agent whose matching parameter has a highest weight, then a match is sought as between the sellers scale item level and the agent's index value defined as a first category level range. If no match exists then based upon the sellers parameter, a same parameter adjacent scale item level is checked for a match termed a second category level range, and if no match is found, then based upon said sellers parameter, a same parameter next adjacent scale item level is checked for a match termed a third category level range, if no match exists the iterative instructions are repeated and instructions for producing an output having a specific agent matched with the seller.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a summary diagrammatic flowchart of the seller and agent collaboration system or method;

FIG. 2 shows a detail diagrammatic flowchart of the seller and agent accounts, the agent criterion parameters, the scale item levels, the associated weights of the scale item levels, the adjacent scale item level, the next adjacent scale item level, the index values, the weights associated with the index values, and wherein the flow chart continues on FIG. 3;

FIG. 3 shows a continuation of the FIG. 2 detail diagrammatic flowchart starting with the matching algorithm that steps through the identical parameters the first category level range checking for a match, if so then an output is made, if not then the second category level range is checked for a match, if so then an output is made, if not then the third category level range is checked for a match, if so then an output is made, if not then the iterative instructions are used to return to the starting matching algorithm to go to a next lower weight parameter from the seller and repeat the process starting with the identical parameters and the first category range, further the output shows the a ranked plurality of agents selected for the seller;

FIG. 4 shows a detail diagrammatic flowchart of the messaging module in particular starting with the seller creating their seller profile that results in the seller credentialed seller data portal and seller created profile database account or termed the seller section, wherein what results in a non-anonymous and an anonymous seller identifications, wherein initially the seller engages with the agent in anonymous one-way communication, being only from the seller to the agent, until the seller accepts two way communication with the seller remaining anonymous and further with the seller accepting two-way communication with the seller being non-anonymous, in addition the agent creates their agent profile that results is the agent credentialed agent data portal and agent created database account or termed the agent section resulting in the non-anonymous agent identification that feeds into the agent pool that is a plurality of agent database accounts;

FIG. 5 shows a diagrammatic flowchart of the seller authentication module that deals with agent criterion parameters that are related to public record real property data that were initially input by the seller in their profile account, the seller authentication module then compares the seller inputted real property scale item levels to matching real property public records to output two lists, one for seller inputted real property scale item levels that match real property public records and another list for seller inputted real property scale item levels that do not match real property public records;

FIG. 6 shows a diagrammatic flowchart of the agent authentication module that deals with agent criterion parameters that are related to agent input index values for the agent criterion parameters that are in the agent's profile database account, the agent authentication module then compares the agent input index values to reviews given to that particular agent by sellers who have used that agent on a matching index value to index value basis for the particular agent as a way to confirm an agent's claim to expertise in any particular area that would be classified as one of the agent's index values for an agent criterion parameter;

FIG. 7 shows a diagrammatic flowchart for the remote host computer setup also known as the “cloud”, having a remote host server computer for the seller and agent collaboration system that includes processors, memory, remote programs, control module, the data communication structure or computer network, the data transfer, carrier wave, and data signal, that is on the network, plus the local human perceptible interface of a phone, tablet, laptop, desktop, and the like, being the local host interface component, and with the seller and agent using the interface;

FIG. 8 shows a screen shot of the seller starting point for creating the seller credentialed seller data portal and the seller profile database account thus making up the seller section;

FIG. 9 shows a screen shot of the seller created and input real property summary based upon a portion of the agent criterion parameters in scale item levels relating to real property;

FIG. 10 shows a screen shot of the agent pool with a summary of each agent for the seller to view;

FIG. 11 shows a screen shot of the single agent having more detail on that particular agent for the seller to view;

FIG. 12 shows a screen shot of the agent starting point for creating the agent credentialed agent data portal and the agent profile database account thus making up the agent section; and

FIG. 13 shows a screen shot of a plurality of seller created and input real property pool summaries based upon a portion of the agent criterion parameters in scale item levels that agents can view;

### DEFINITIONS

Agent=an entity who acts as an agent for the seller as a principal to basically do the marketing and promotion of the article or property and arrange for the consummation of the article or property sale.
Agent Authentication Module=certification of agent profile individual index values through agent feedback review ratings by only sellers who have had a transaction with that particular agent.
Agent Created Agent Profile=created by an agent resulting in a saved agent database that includes individual agent criterion index values for each agent criterion parameter.
Agent Criterion=a plurality of agent and property parameters that are priority matched as between the seller and the agent such that a particular agent is a “best fit” for the seller. These criterion can include but are not limited to;
1. Team approach
2. Singular approach
3. Time priority agent
4. Completeness priority agent
5. Number of years' experience as an agent
6. Number of transactions closed by the agent
7. Type of transactions closed by the agent
8. Geographic specialty of agent
9. Seller selling urgency level
10. Agent feedback rating
11. Property type specialty of agent
12. Agent bio including college education, work history, military, geographic working and living history.
13. Agent multiple language fluency.
14. Agent license history
15. Address of property
16. Configuration of detached or duplex, three-plex, four-plex, condo, apartment, and/or with basement, i.e. the property type.
17. Desired price level range
18. Number of bedrooms
19. Number of bathrooms
20. Square feet of living area
21. Square feet of lot if applicable
22. Property style being ranch, two story, three story, bi-level, or tri-level.
23. Amenities nearby such as schools, shopping, grocery, restaurants, gas stations, banks, post office, building supplies, parks, public transit, and churches.
24. Neighborhood features such as hilly, mountains, flat, creeks, rivers, lakes, ocean, and lake/ocean front, crime rates, walkability, bicycle friendly, and the like.
25. Property special features such as pool, drive through driveway, RV and/or boat parking, solar, generator, pet friendly, fireplace, sprinkler system, dead end street, and the like.
26. Property tax history
27. Sales Price history
28. Heating system
29. Cooling system
30. Electrical system
31. Solar
32. Materials of construction
33. Text, photo, video, and audio of the property
34. Area demographics
35. Mortgages on the property
36. Mortgage amount, age, interest rate, and assumable status of each mortgage.
37. Liens on the property.
38. Property deed type and status
39. Age of property
40. Age of roof
41. Age of appliances
42. Easements
43. Mineral and other rights
44. Environmental issues with land including sink holes, contamination, soil composition
45. Flood plane
46. Mold, water, insect infestation
47. Pets in property
48. Smokers in property
49. Chemical contamination of building
50. Building physical/structural issues such as cracks, settling, or heaving
51. Building code/permit issues/zoning issues
52. Aluminum wire
53. Pipe material
54. Smoke detector system
55. Carbon monoxide detector system
56. Security system
57. General condition of property
58. Warranties
59. Inclusions
60. Exclusions
61. Electrical system
62. Sewer system
63. Water system
64. Condemnation
65. Covenants
66. Easements
67. Encroachments
68. Home Owners Association
69. Leases
70. Insurance history
71. Eminent domain
72. Legal description of the lot
73. Parking spaces-off street, carport, or garage
74. Neighborhood crime situation
Agent Database=stores all of an agents selectable preferences including access credentials, agent profile index values for each agent criterion, and an agent weight selected for each agent criterion.
Agent Pool Profiles=a group of multiple agent profiles a portion of which meet the seller profile, being ranked by a first best match and subsequently a declining ranking of best fit matches for agents to the seller.
Confidential Seller Communication Portal=facilitates initial one-way communication of seller to agent wherein seller remains anonymous in relation to agent and facilitates the first communication to only be from seller to agent and blocking initial communication from agent to seller.
Confirm Agent(s) Availabililty=Once an agent or a plurality of agents are selected by the matching algorithm, prior to presenting the agent or agents to the seller to choose from, the agent(s) need to indicate a positive response for their availability to potentially become the seller's agent or a negative response thus indicating that the agent(s) is not available resulting in that the negative response agent(s) not being presented to the seller.
Credential protected Portal for Agent=limited access to only allow a single agent access to their specific account in the agent database.
Credential protected Portal for Seller=limited access to only allow a single seller access to their specific account in the seller database.
Index values=agent created separate information for each agent criterion parameter as input values.
Index value separate Agent weights=agent assigned importance weight for each index value
Matching algorithm=a dynamic matching of the seller profile and the agent profile
1. The matching algorithm breaks down into two parts;

i. Priority rank ordering of each of the seller created agent individual criterion parameters scale item levels from highest item to lowest item with assigned relative weights for each agent criterion parameter and to match these scale item levels to each individual agent criterion parameter index values based on each of their weighting, irrelevant to a particular seller agent criterion parameter or a particular agent or agent criterion parameter.

ii Agent criterion ranges there are three categories of ranges, a first or closest mating range of the equal highest weight agent criterion of the seller, that is one agent weighted criterion parameter from the seller and one agent weighted criterion parameter from the agent, matched as an equal weight pair wherein the agent criterion parameter can be different or the same from the seller and agent being of an equal ranking weight pair from the seller and agent respectively, if there is no match at the first category level range, then a second category level range entails going to an adjacent range again on the seller side and to search for an agent match at an equal weight agent criterion level, subsequent to this if there is no match at the second category level, then a third category level range goes another next adjacent step range of the seller side looking for a match at an equal weight agent criterion level, if subsequent to this no match is found, then the same process is repeated for the second highest seller based weight agent criterion and in going through the first, second, and third category level ranges from the seller and so on for what is termed the iterative instructions.
1. As property price, property square footage, or property lot size increase, the dynamic matching selects a smaller group of agent pool profiles for the seller profile by narrowing ranges of available match ranges by only going to the second category level range match or only the first category level range match before dropping down to the second highest seller based weight agent criterion parameter. This is to tighten the qualification of agents to sellers as the size of the transaction increases.
2. Further as property price, property square footage, or property lot size decrease the dynamic matching selects a larger group of agent pool profiles for the seller profile by expanding ranges of available match by going from a first category level range match only expanding out to second and third category range matched matches as previously described. This is to loosen the qualification of agents to sellers as the size of the transaction decreases.
3. If seller profile requires a high seller urgency level then time priority agent shall become the highest weight criterion of the matching algorithm.
Matching algorithm output=selecting the best fit single agent for the seller and suggesting a remaining plurality of agents for the seller ranked from closest match to least closest match
Messaging module=facilitates the confidential seller communication portal.
First category level range=a first or closest mating range of the equal highest weight agent criterion parameter of the seller, that is one agent criterion parameter from the seller and one agent criterion parameter from the agent, wherein the criterion can be different or the same, being of equal ranking weight from the seller and agent respectively, if the respective parameters from the seller and agent are not identical then the second category level range is employed.
Second category level range=if there is no match at the first category level range, then a second category level range entails going to an adjacent range again for the parameter on the seller side and search for an agent match at an equal weight agent criterion parameter level.
Third category level range=if there is no match at the second category level range, then a third category level range goes another next adjacent step range of the seller side agent criterion parameter looking for a match at an equal weight agent criterion parameter level.
Scale item levels=seller created individual requirements for each agent criterion parameters as input values for each parameter.
Scale item level separate seller weights=seller assigned importance weight for each scale item level.
Seller=the owner of an article or property who desires to sell the article or property.
Seller authentication module=using a non-anonymous seller identification a certification of property and ownership via confirmation of the seller created individual scale items of the agent criterion parameters with outside sources of information such as government or public property records.
Seller created seller profile=created by a seller resulting in a saved seller profile database account that includes agent individual criterion scale item levels for each agent parameter.
Seller criterion parameters=agent criterion parameters
Seller Created Database=stores all of an seller's selectable preferences including access credentials, seller scale item levels for each agent criterion parameter, and a seller weight selected for each agent criterion parameter.

### REFERENCE NUMBERS IN DRAWINGS

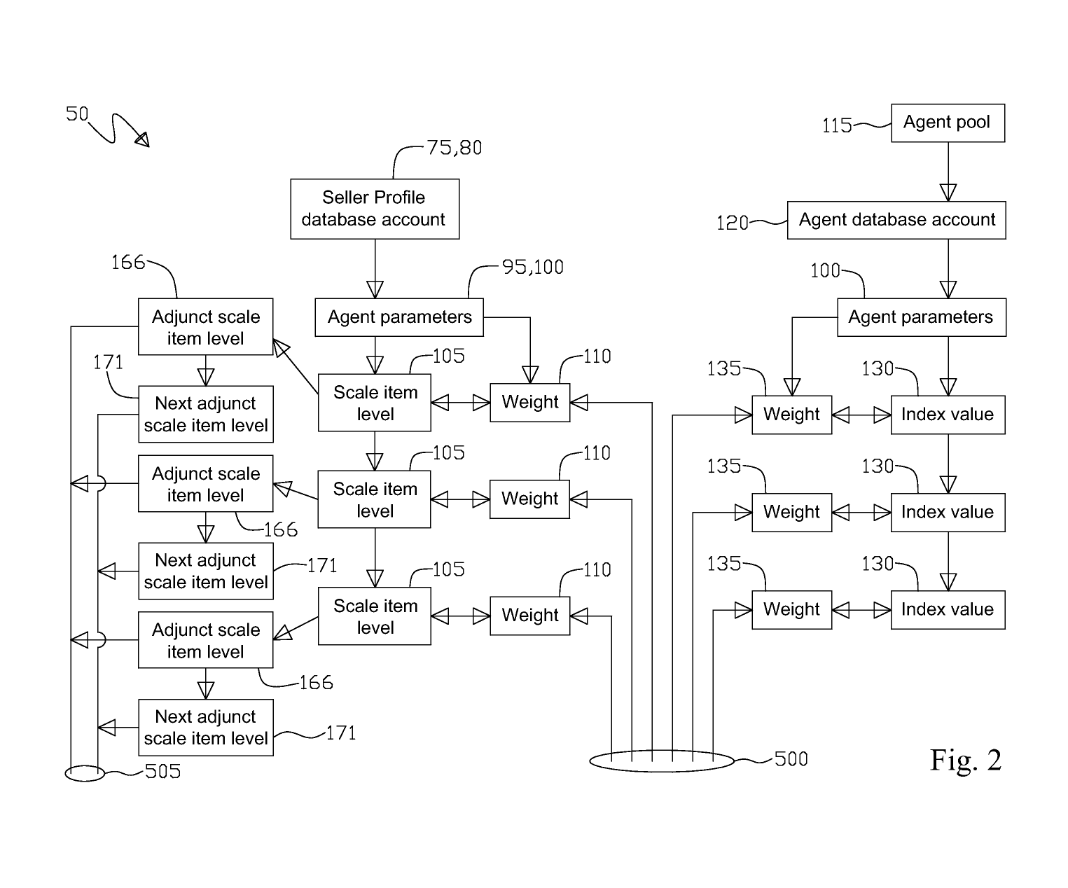

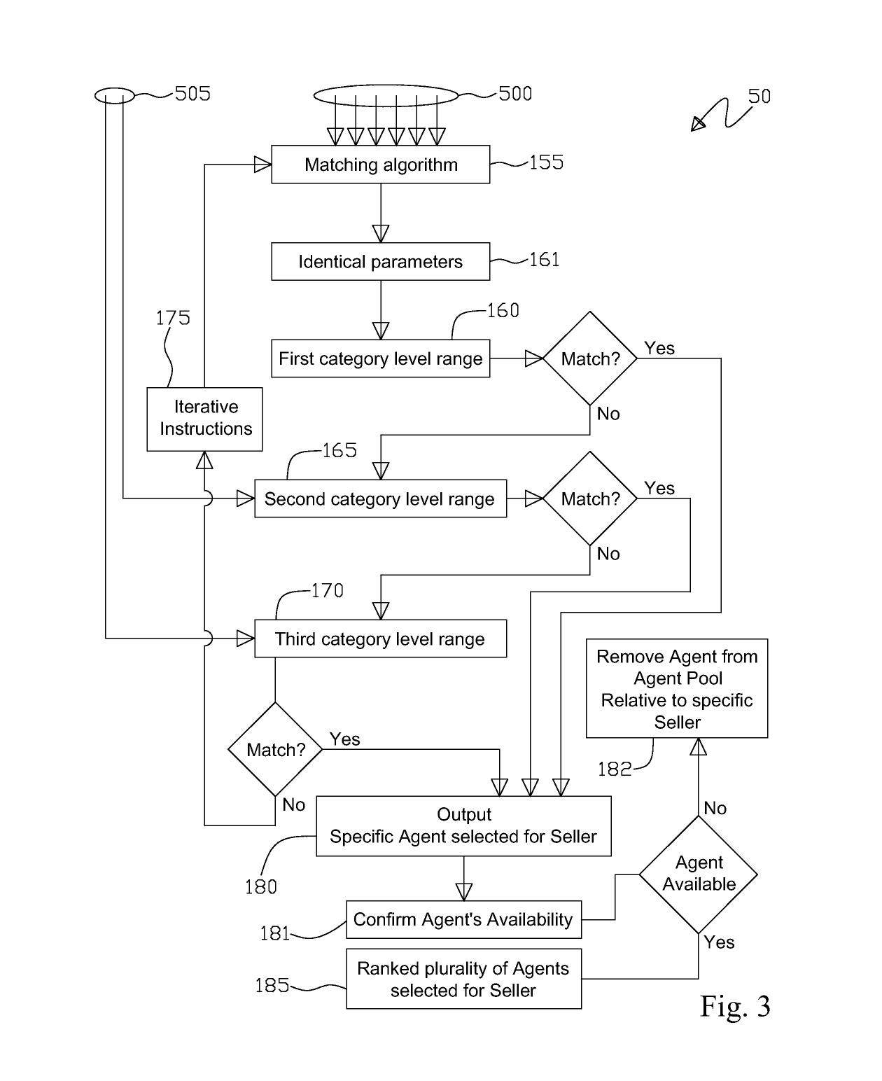

50 Seller and Agent Collaboration System
55 Seller
60 Agent
65 Real Property
70 Credential protected seller 55 data portal
75 Seller 55 section
80 Single seller 55 profile database account
85 Non-anonymous seller 55 identification
90 Anonymous seller 55 identification
95 Agent 60 criterion
100 Agent 60 parameters
105 Scale item level as a seller 55 input for each parameter 100
110 Seller 55 selected weight associated with each parameter 100
105 Credential protected agent 60 data portal
106 Blocking communication from agent 60 to seller 55—one way communication
110 Agent 60 section
115 Agent pool
120 Single agent 60 profile database account
125 Non-anonymous agent 60 identification
130 Index value as an agent 60 input for each parameter 100
135 Agent 60 selected weight associated with each parameter 100
140 Processors
145 Memory
150 Programs/instructions
155 Matching algorithm
160 First category level range
161 Identical parameters 100
165 Second category level range
166 Adjacent scale item level 105
170 Third category level range
171 Next adjacent scale item level 105
175 Iterative instructions
180 Output of specific agent 60 selected for the seller 55
181 Confirm agent(s) 60 availability for seller 55
182 Remove agent 60 from agent pool 115 relative to a specific seller 55
185 Plurality of agents 60
190 Messaging module
195 Confidential seller 55 communication portal
200 Initial anonymous one-way only communication from seller 55 to agent 60
205 Blocking communication from the agent 60 to the seller 55
210 Subsequent communication as between the seller 55 and agent 60 that is two-way communication
215 Seller 55 authentication module
220 Public records
225 Agent 60 authentication module
230 Seller 55 reviews of agents 60 used
235 Remote access apparatus
240 Remote program
245 Local host interface component
250 Remote host server computer
255 Data communication structure or computer network
260 Data transfer
265 Local human perceptible interface, being in the form of a phone, tablet, laptop, desktop, and the like
270 Local control module
275 Method for matching a seller 55 and an agent 60
280 Carrier wave
285 Data signal
290 Screen shot seller 55
295 Screen shot real property 65
300 Screen shot agent pool 115
305 Screen shot agent 60
310 Screen shot agent 60 account 120
315 Screen shot real property 65 pool
500 Flowchart continuation match as between FIGS. 2 and 3 for the seller 55 weights
110 and the agent 60 weights 135
505 Flowchart continuation match as between FIGS. 2 and 3 for the second 165 and third 170 category level ranges to the adjacent scale item levels 105 and the next adjacent scale item levels 105 respectively

### DETAILED DESCRIPTION

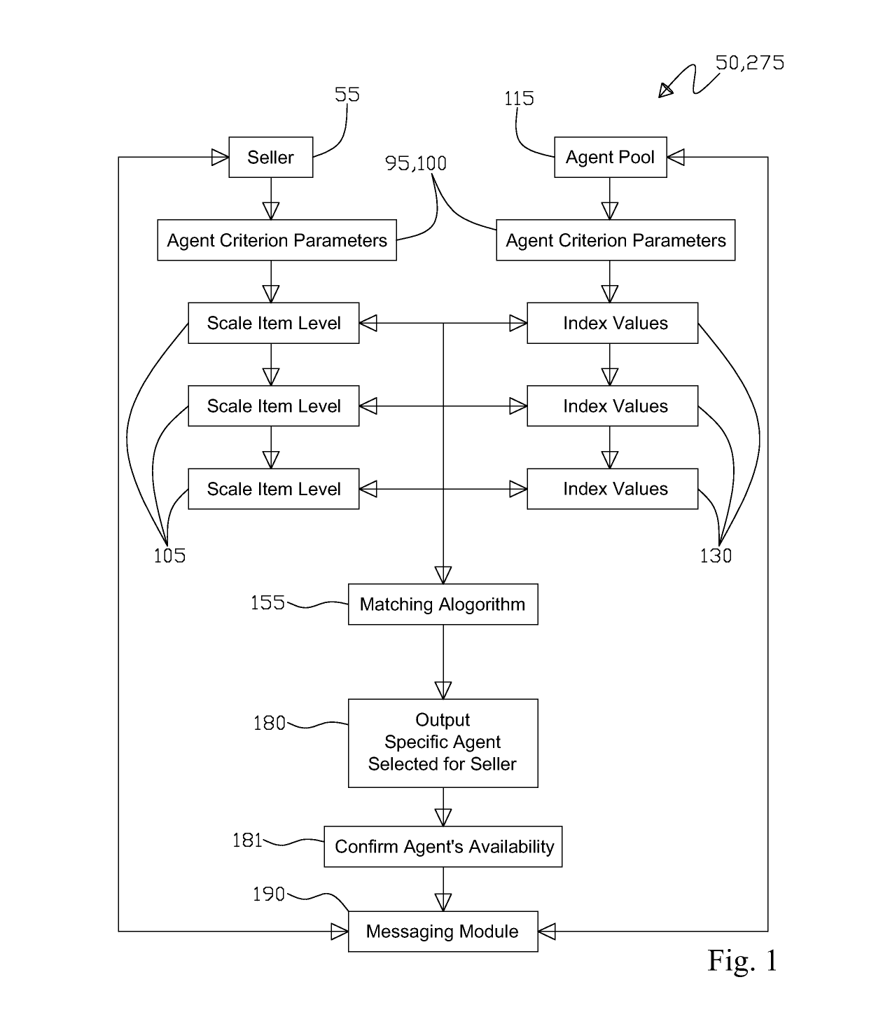

With initial reference to FIG. 1, shown is a summary diagrammatic flowchart of the seller and agent collaboration system 50 and FIG. 2 shows a detail diagrammatic flowchart of the seller 80 and agent 120 accounts, the agent criterion 95 parameters 100, the scale item levels 105, the associated weights 110 of the scale item levels 105, the adjacent 166 scale item level 105, the next adjacent 171 scale item level 105, the index values 130, the weights 135 associated with the index values 130, and wherein the flow chart continues 500, 505 on to FIG. 3.

Continuing to FIG. 3 shows a continuation 500, 505 of the FIG. 2 detail diagrammatic flowchart starting with the matching algorithm 155 that steps through the identical parameters 100 the first category level range 160 checking for a match, if so then an output 180, 185 is made, if not then the second category level range 165 is checked for a match, if so then an output 180, 185 is made, if not then the third category level range 170 is checked for a match, if so then an output 180, 185 is made. As FIG. 3 shows, if still no match then the iterative instructions 175 are used to return to the starting matching algorithm 155 to go to a next lower weight 110 parameter from the seller 55 and repeat the process starting with the identical parameters 100 and the first category range 160, further the output 180 shows the a ranked plurality of agents 185 selected for the seller 55.

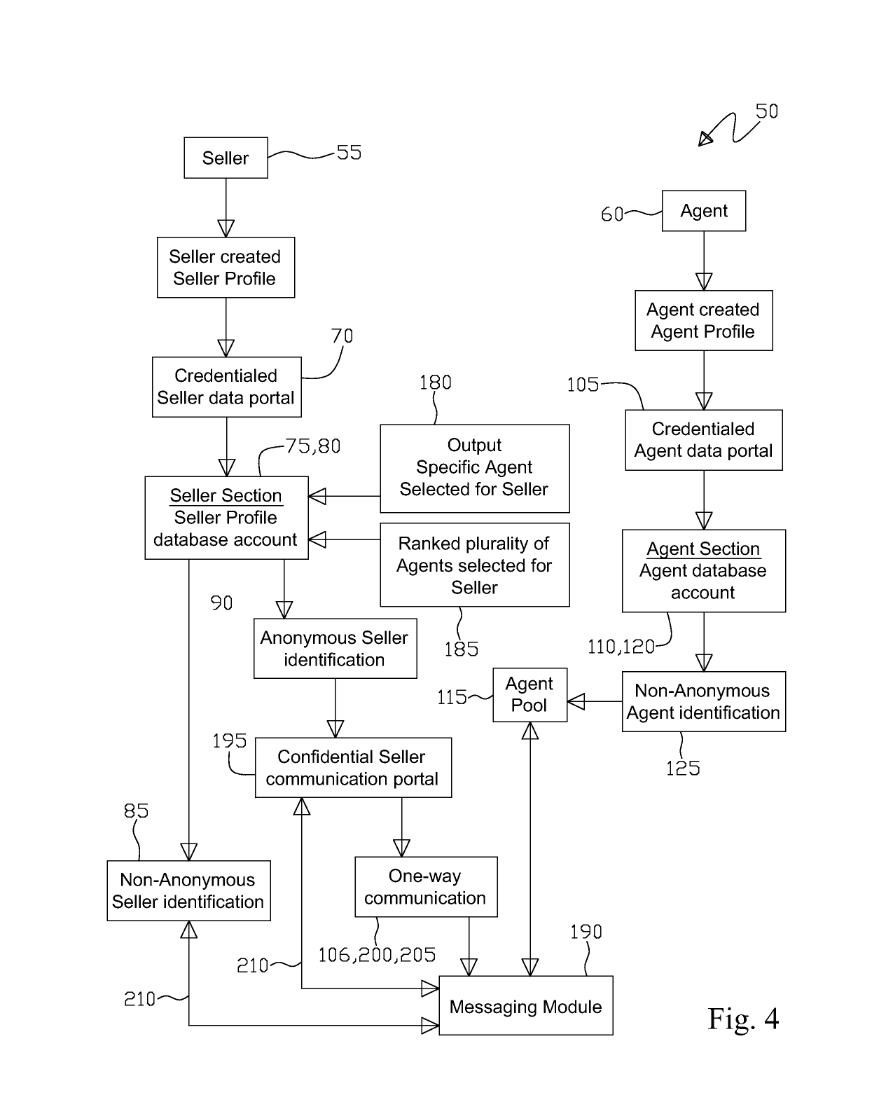

Next, FIG. 4 shows a detail diagrammatic flowchart of the messaging module 190 in particular starting with the seller 55 creating their seller profile 80 that results in the seller credentialed seller data portal 70 and seller created profile database account 80 or termed the seller section 75. Wherein what results in FIG. 4 is a non-anonymous 85 and anonymous 90 seller identifications, through the confidential portal 195, wherein initially the seller 55 engages with the agent 60 in anonymous one-way communication 106, 200, 205 being only from the seller 55 to the agent 60, until the seller 55 accepts two way communication 210 with the seller 55 remaining anonymous 90, and further with the seller 55 accepting two-way communication 210 with the seller 55 being non-anonymous 85. In addition, shown in FIG. 4, the agent 60 creates their agent profile 120 that results is the agent credentialed agent data portal 105 and agent 60 created database account 120 or termed the agent section 110 resulting in the non-anonymous 125 agent identification that feeds into the agent pool 115 that is a plurality of agent database accounts 120.

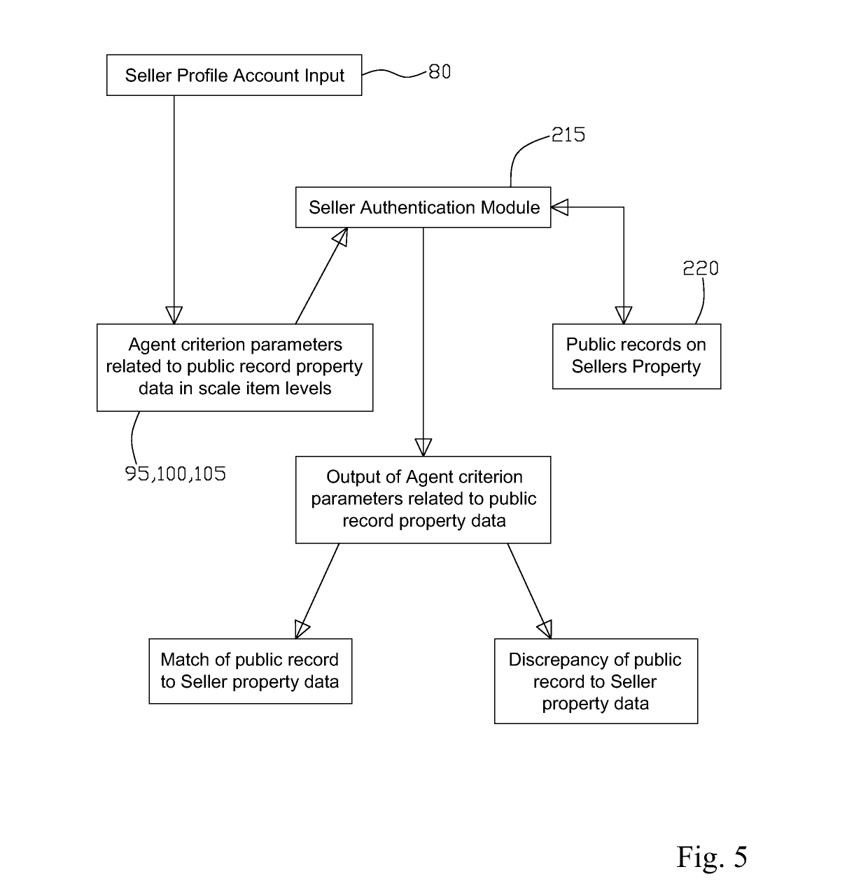

Moving onward, FIG. 5 shows a diagrammatic flowchart of the seller authentication module 215 that deals with agent criterion 95 parameters 100 that are related to public record real property data 220 that were initially input by the seller 55 in their profile account 80, the seller authentication module 215 then compares the seller 55 inputted real property scale item levels 105 to matching real property public records 220 to output two lists, one for seller inputted real property scale item levels 105 that match real property public records 220 and another list for seller inputted real property scale item levels 105 that do not match real property public records 220.

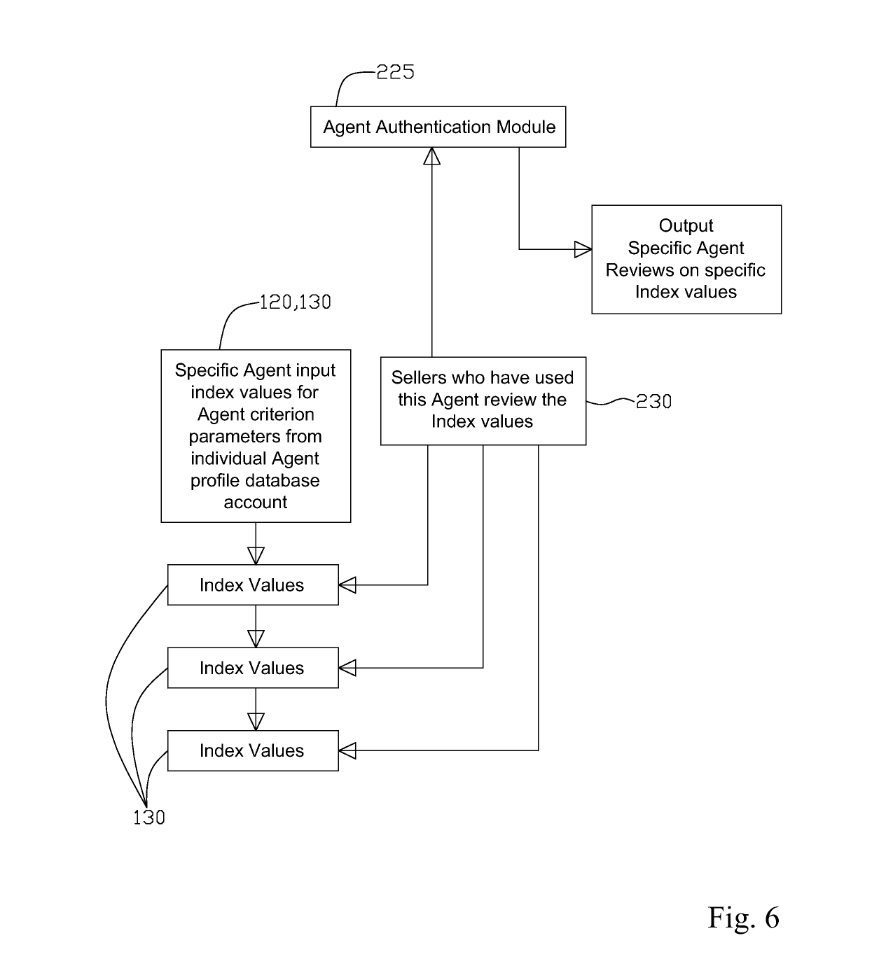

Continuing, FIG. 6 shows a diagrammatic flowchart of the agent authentication module 225 that deals with agent criterion 95 parameters 100 that are related to agent input index values 130 for the agent criterion 95 parameters 100 that are in the agent's profile database account 120, the agent authentication module 225 then compares the agent input index values 130 to reviews 230 given to that particular agent 60 by sellers 55 who have used that agent 60 on a matching index value 130 to index value 130 basis for that particular agent 60 as a way to confirm an agent's 60 claim to expertise in any particular area that would be classified as one of the agent's index values 130 for an agent criterion 95 parameter 100.

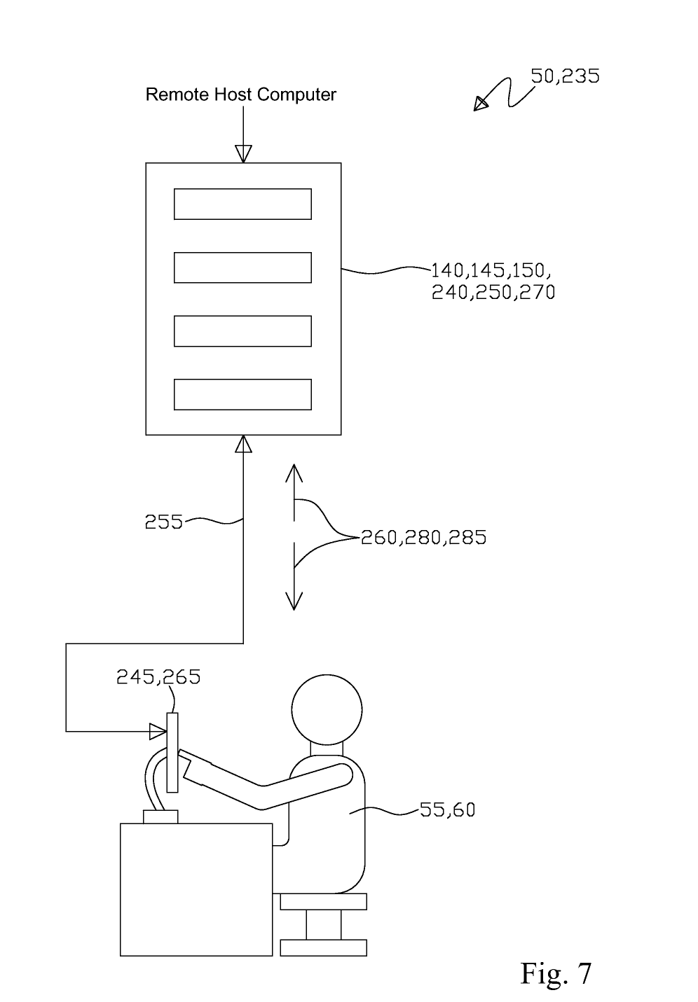

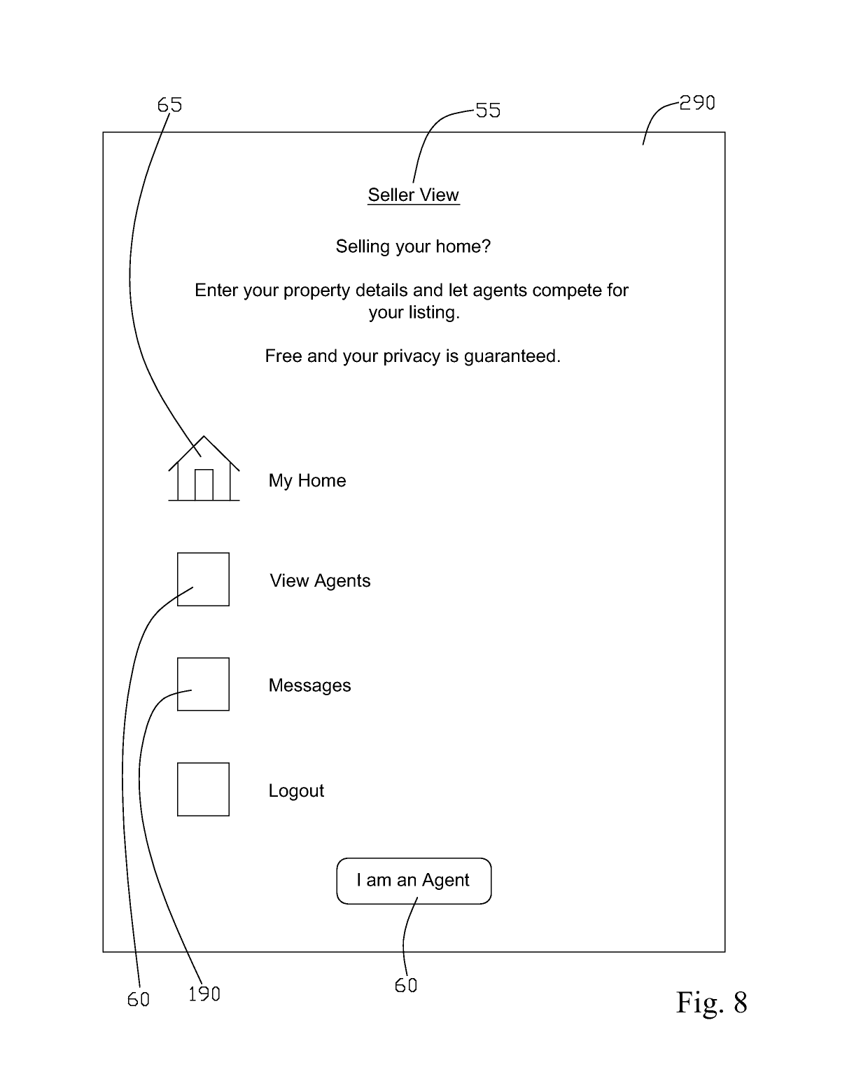

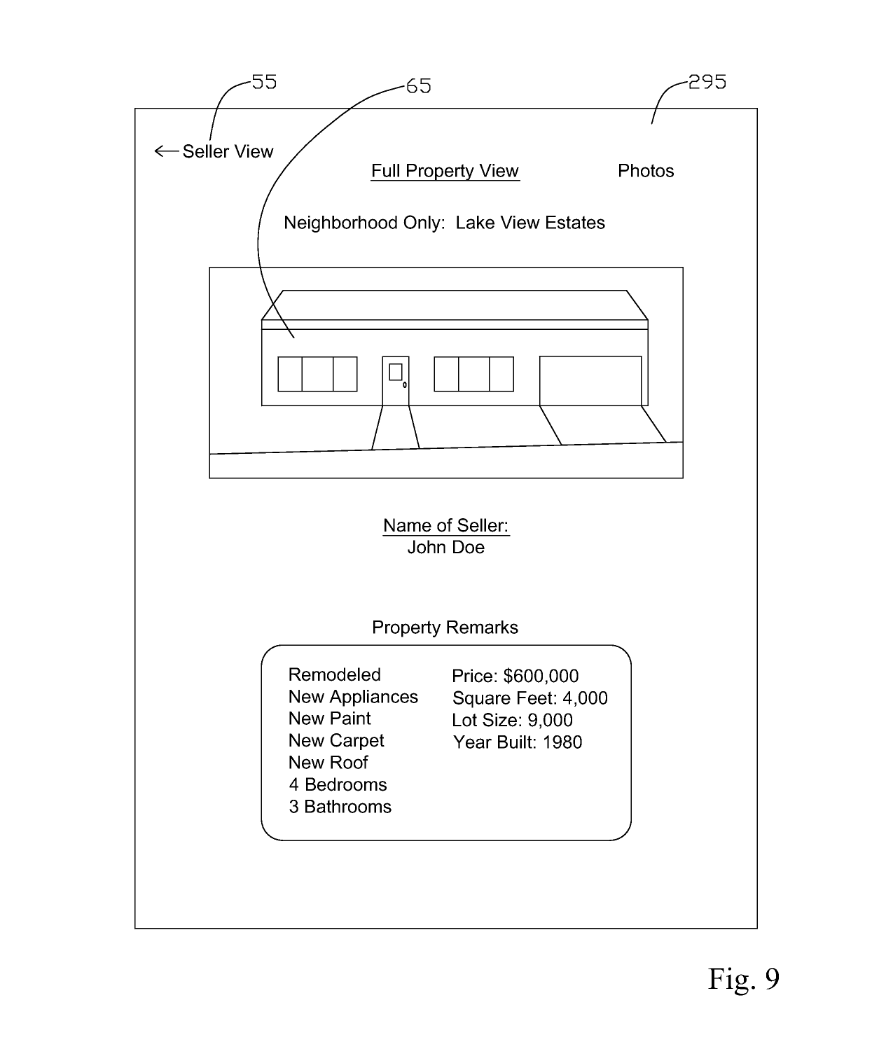

Further, FIG. 7 shows a diagrammatic flowchart for the remote host computer setup 235 also known as the “cloud”, having a remote host server computer 250 for the seller and agent collaboration system 50 that includes processors 140, memory 145, remote programs 150, 240, 270 control module, the data communication structure 255 or computer network, the data transfer 260, carrier wave 280, and data signal 285 that is on the network 255, the local human perceptible interface 265 of a phone, tablet, laptop, desktop, and the like, being the local host interface component 245, and the seller 55 or agent 60 using the interface 245. Next, FIG. 8 shows a screen shot of the seller 55 starting point 290 for creating the seller 55 credentialed seller data portal 70 and the seller 55 profile database account 80 thus making up the seller 55 section 75. Next, FIG. 9 shows a screen shot 295 of the seller created and input real property 65 summary based upon a portion of the agent criterion 95 parameters 100 in scale item levels 105.

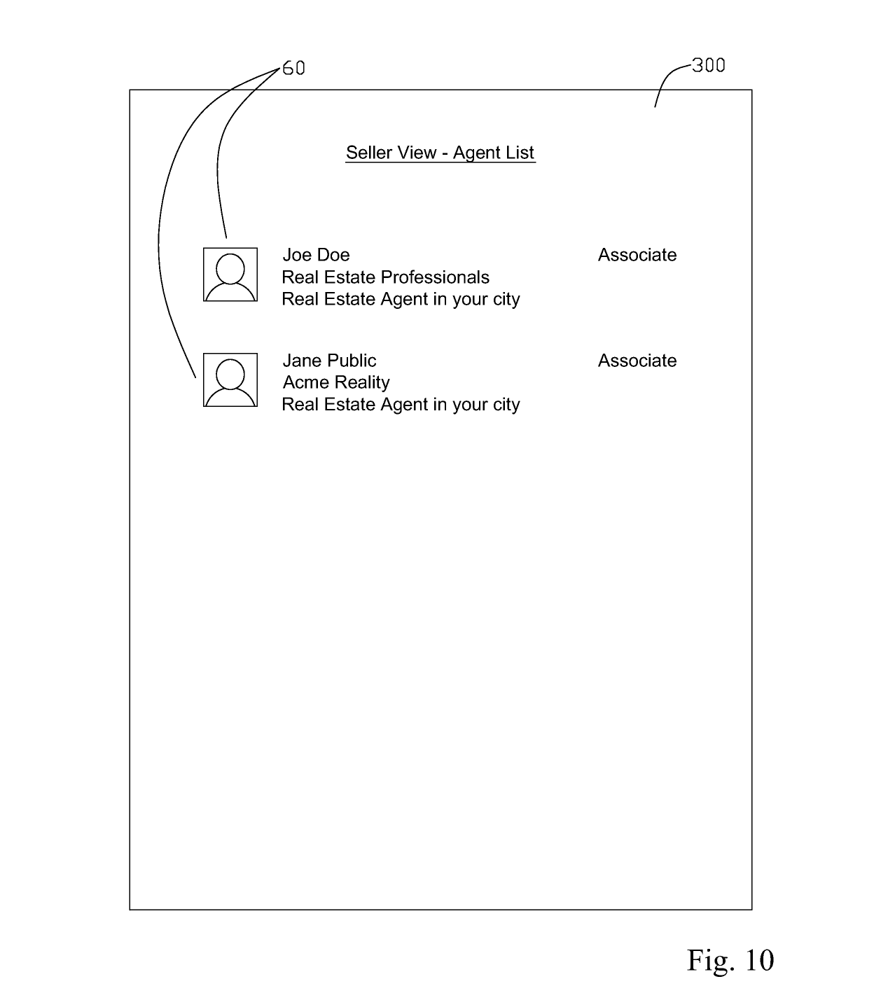

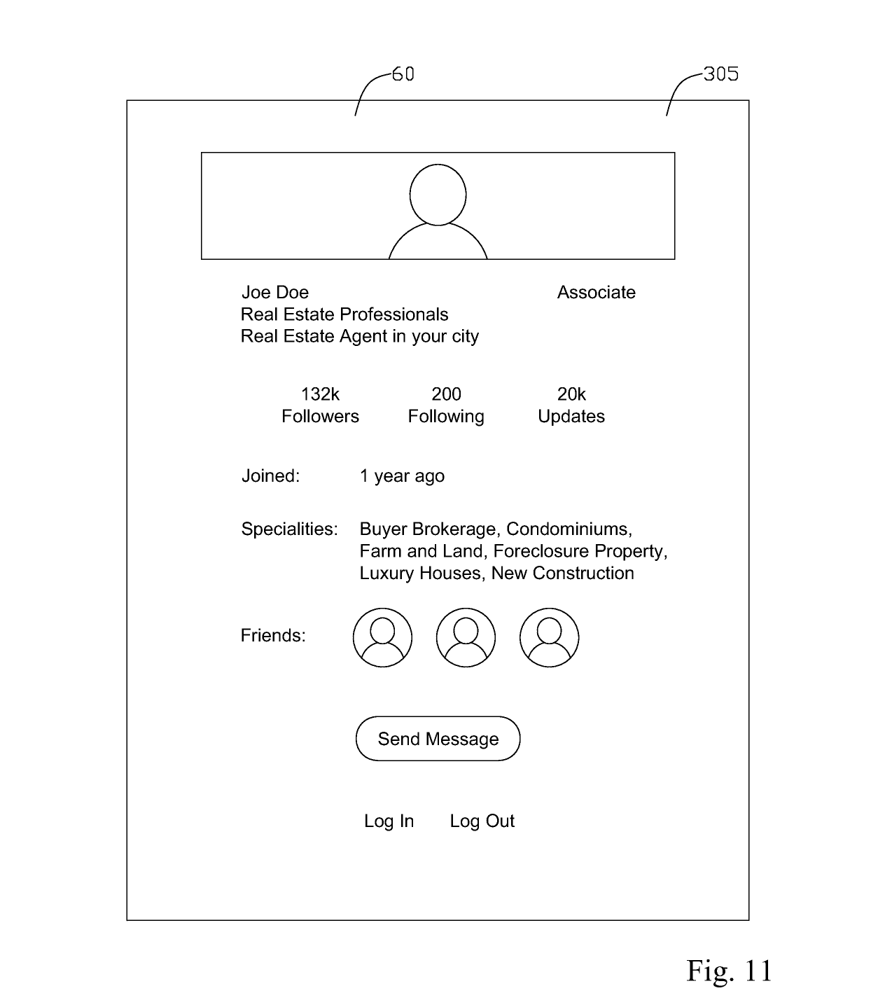

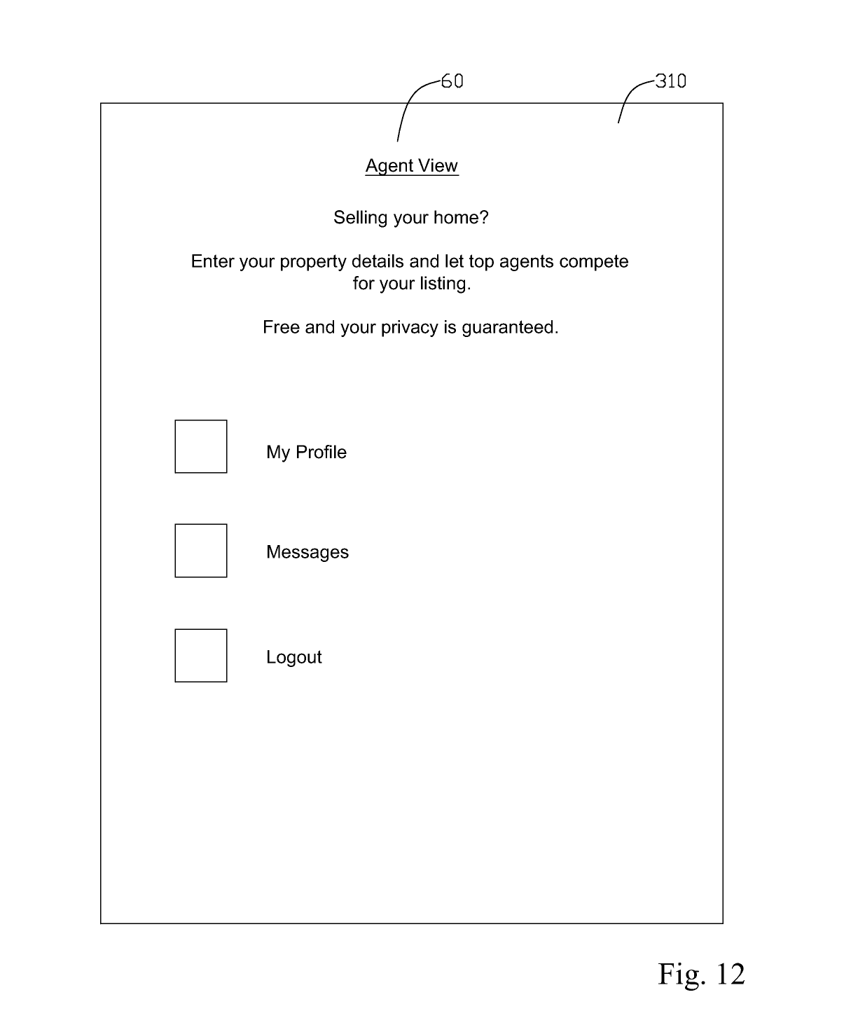

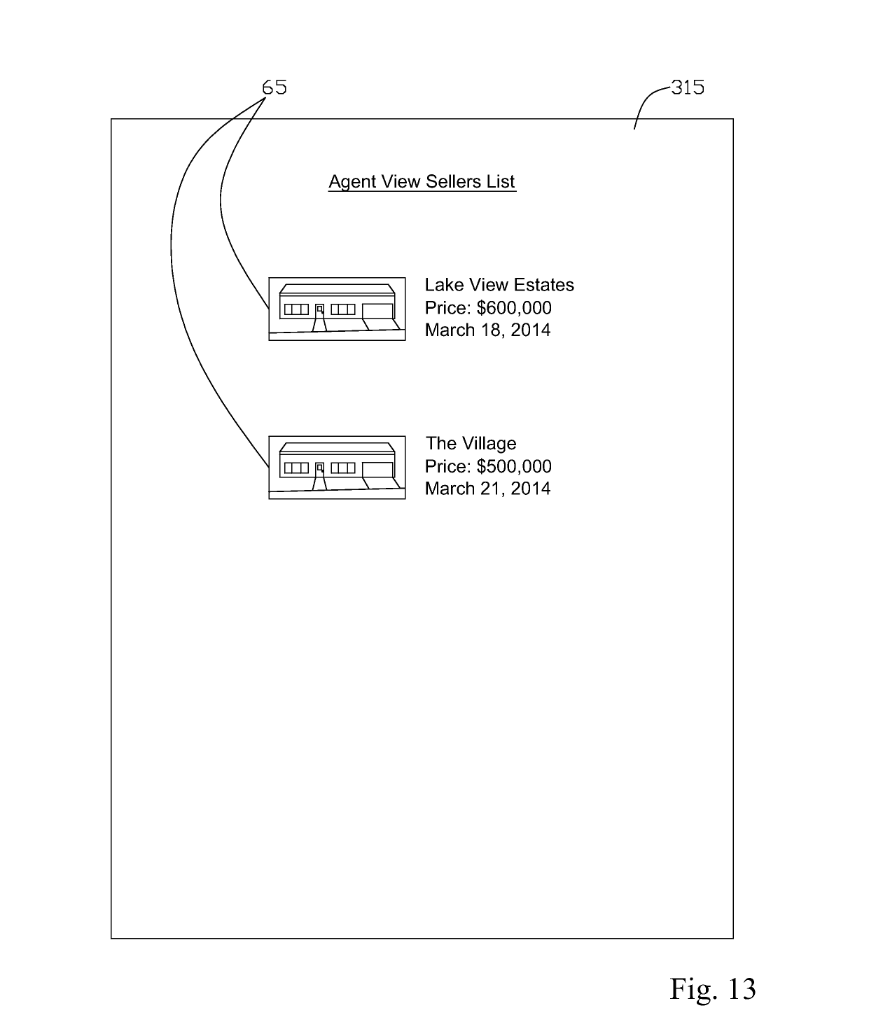

Continuing, FIG. 10 shows a screen shot 300 of the agent pool 115 with a summary of each agent 60 for the seller 55 to view and FIG. 11 shows a screen shot 305 of the single agent 60 having more detail in the form of index values 130 on that particular agent 60 for the seller 55 to view. Next, FIG. 12 shows a screen shot 310 of the agent 60 starting point for creating the agent credentialed agent data portal 105 and the agent profile database account 120 thus making up the agent section 120. Continuing, FIG. 13 shows a screen shot 315 of a plurality of seller 55 created and input real property pool 65 summaries based upon a portion of the agent criterion 95 parameters 100 in scale item levels 105 that agents 60 can view.

Broadly, in looking at FIGS. 1 to 7, the present invention is of a seller 55 and agent 60 collaboration system 50 for matching a seller 55 with an agent 60 to help consummate a sale of real property 65. Wherein the system 50 includes a credential protected seller 55 data portal 70 for a single seller 55 to gain access to a seller section 75 and a single seller profile database account 80 created with a non-anonymous 85 seller 55 identification and an anonymous 90 seller 55 identification, as best seen on FIGS. 1 and 4. The seller 55 profile database account 80 includes an agent criterion 95 that has a plurality of agent parameters 100, wherein the seller 55 inputs a unique scale item level 105 for each of the plurality of agent parameters 100 in addition to the seller inputting a unique seller 55 selected weight 110 associated with each agent parameter 100, see FIG. 2. Further included is a credential protected agent 60 data portal 105 for a single agent 60 to gain access to an agent section 110 and a plurality 115 of single agent database accounts 120 defined as an agent pool 115, see FIGS. 2 and 4. Each single agent 60 profile database account 120 is created with a non-anonymous 125 agent 60 identification, the agent 60 profile database account 120 includes an agent criterion 95 that has a plurality of agent parameters 100, wherein the agent 60 inputs an index value 130 for each of the plurality of agent parameters 100 in addition to the agent 60 inputting a unique agent 60 selected weight 135 associated with each agent parameter 100, see FIG. 2.

In addition, looking at FIG. 3 in particular, there are instructions 150 for producing a matching algorithm 155 as between the seller 55 profile database account 80 and the agent pool 115 being the plurality of single agent 60 database accounts 120, the matching algorithm 155 has a priority rank ordering of the seller 55 selected weights 110 associated with each agent 60 parameter that are matched with each of the plurality of unique agent 60 selected weights 135 associated with each agent parameter 100 such that the seller 55 selected parameter weights 110 and the agent 60 selected parameter weights 135 are equally matched in a pair irrelevant to a particular agent criterion parameter 100 of the seller 55 or the agent 60. Further, for each equal weighted pair, if the equal weighted pair has identical 161 parameters 100 then a match is sought as between the sellers 55 scale item level 105 and the agent's 60 index value 130, termed a first category level range 160, if no match exists then based upon the sellers 55 parameter 100, a same parameter 100 adjacent scale item level 166 is checked for a match termed a second category level range 165, see FIGS. 2 and 3.

Further, if no match is found, then based upon the sellers 55 parameter 100, a same parameter 100 next adjacent scale item level 171 is checked for a match termed a third category level range 170, if no match exists or the equal weight 110, 135 sellers 55 and agent 60 parameters are not the same, iterative instructions 175 are such that sellers 55 next highest weight 110 parameter 100 scale item level 105 is matched to the agent pool 115 to a specific agent 60 whose matching 161 parameter 100 has a highest weight 135, then a match is sought as between the sellers 55 scale item level 105 and the agent's 60 index value 130 defined as a first category level range 160, again see FIGS. 2 and 3. If no match exists then based upon the sellers 55 parameter 100, a same parameter 100 adjacent 166 scale item level 105 is checked for a match termed a second category level range 165, and if no match is found, then based upon said sellers 55 parameter 100, a same parameter 100 next adjacent scale item level 171 is checked for a match termed a third category level range 170, if no match exists the iterative instructions 175 are repeated and instructions for producing an output 180, 185 having a specific agent 60 matched with the seller 55, again see FIGS. 2 and 3.

As an example for the matching algorithm 155, focusing on FIGS. 2 and 3, if the seller 55 had a highest weight 110 scale item level 105 of “Geographic specialty-say a particular neighborhood, i.e. Harvey Park” and the seller 55 also had a second highest weight 110 scale item level 105 of “Property type/style specialty-say for instance a tri-level” and the agent 60 had a highest weight 135 index value 130 of “Property type/style specialty-say for instance a single level ranch” and the agent 60 had a second highest weight 135 index value 130 of “a property price range of $200K to $300K, this is what the matching algorithm 155 would do; Don't forget there will be a pool of agents 115, we are just using a single agent 60 as an example, thus to start with there will not be a match on the highest weights 110, 135 for the seller 55 and agent 60 respectively as the seller 55 has an scale item level 105 of neighborhood specialty of “Harvey Park” and the agent 60 has an index value 130 of “single level ranch”—so we have no match, also we would have no match even if the agent 60 had a top weight 135 index value 130 of another neighborhood such a Bear Valley, however, in that case the first category range 160 would not apply because there was no direct match and thus we move to the second category level range 165 based on the seller's 55 scale item level 105 we would look for a match at an adjoining neighborhood, which here we have as Bear Valley (agent's 60 index value 130) that is adjacent to Harvey Park (seller's 55 scale item level 105), so we would have a match at a second category level range 65.

Going back to what we originally had, the seller 55 had a highest weight 110 scale item level 105 of “Harvey Park” neighborhood and the agent 60 had a highest weight 135 index value 130 of “single level ranch”, so even at the first 160, second 165, and third 170 category level ranges, we have no match, so next through the iterative instructions 175 we go to the seller's 55 next highest weight 110 scale item level 105 of “tri-level” wherein the agent 60 has a highest weight 135 index value 130 of “ranch single level”, so still no match, wherein we have no first category match 150 and even with a second category level range 165 being an adjacent scale item level 105 of “bi-level” on the seller's 55 side we have no match, however, on the third category level range 170 of 165 being an adjacent scale item level 105 of “ranch single level” we have a match as between the seller 55 and agent 60. If no matches are found in the agent pool 115, then the agents 60 are priority ranked first on a weight 110, 153 match and second on a first 160, second 165, or third 170 category level range match for the seller 55, however, there is always a “best” match agent 60 to seller 55 that is the output 180 and the subsequent lesser matches output 185 from the agent pool 115 for the seller 55. Further instructions can be given for confirming the specific agent 60 being available for the seller 55, wherein the specific agent 60 indicates a positive response for availability to the seller 55 or a negative response for non-availability to the seller 55, if a negative response the specific agent 60 is removed 182 from the agent pool 115 relative to that particular seller 55 and the step for the matching algorithm 155 is repeated, see FIGS. 1 and 3.

As an option on the seller and agent collaboration system 50 the first 160, second 165, and third 170 category level ranges are truncated to the first category level range 160 only when the agent criterion parameter 100 is above a selected amount being selected from the group consisting of a desired real property price level range, a square feet of living area, and a square feet of lot area as either scale item levels 105 or index values 130. As an example for the desired real property 65 price range from the seller 55 on the scale item level 105, say if the selected amount price is above $500K, then the matching algorithm 155 is optionally going to demand a “tighter fit” of the match of the agent 60 to the seller 55, essentially eliminating the second 165 and third 170 category level ranges of adjacent and next adjacent scale item levels 105 of the seller 55, thus requiring an identical parameter 100 match being the scale item level 105 of the seller 55 to the index value 130 of the agent 60. Thus, in this case the agents 50 are priority ranked on weight 110, 135 alone with the seller's 55 weight 110 or next highest weight 110 for the scale item level 105 being compared or matched to the pool 115 of agents 60 weights 135 for their index values 130, with the possible agent 60 options for the seller 55 for the outputs 180, 185.

Also as an option, for the seller and agent collaboration system 50 the instructions 150 for producing an output 180 can further include a plurality 185 of agents 60 matched with the seller 55, wherein the plurality 185 of agents 60 are ranked from a second closest match to the seller 55 to a least closest match to the seller 55, see FIGS. 3 and 10.

To further enhance agent 60 and seller 55 communication privacy for the seller and agent collaboration system 50, a messaging module 190 can be added to enable a confidential seller 55 communication portal 195 that facilitates an initial anonymous 90 one-way only communication 106, 200, 205 from seller 55 to agent 60 thus blocking communication 205 from the agent 60 to the seller 55, and subsequent communication as between the seller 55 and agent 60 that is a two-way communication 210 wherein the seller 55 remains anonymous 90 until the seller 55 selectably engages in non-anonymous 85 two-way communication 210 with the agent 60. This is to protect the seller 55 from sales agent 60 solicitation via letting the seller 55 communication with the agent 60 in a less threatening manner, see in particular FIG. 4.

To enhance credibility and accuracy of the seller and agent collaboration system 50, and in looking at FIG. 5, a seller 55 authentication module 215 can be added that is to certify property 65 related parameters from public records 220 that are from the agent criterion 95 parameters 100 relating to the seller 55 profile database account 80 input, wherein the real property 65 related parameters are selected from the group consisting of property type, square feet of living area, property tax history, number of bedrooms, square feet of lot, heating/cooling system, materials of construction, lot legal description, number of bathrooms, age of property, and parking-off street/carport/garage, and other related items. Being basically seller 55 real property 65 scale item levels 105 of information that can be verified independently from a third party source such as government records, wherein an output of verified and non-verified real property 65 scale item levels 105 from the seller 55 can be listed.

Further, to enhance credibility and accuracy of the seller and agent collaboration system 50, and in looking at FIG. 6, an agent authentication module 225 can be added that is to certify agent 60 related parameters 100 by agent 60 feedback reviews 230 by only sellers 55 who have used that particular individual agent 60. The individual index values 130 of the agent criterion 95 parameters 100 that are from the individual agent 60 profile database account 120 that are selected from the group consisting of team approach, singular approach, time priority agent, completeness priority agent, number of years' experience as an agent, number of transactions closed by the agent, type of transactions closed by the agent, geographic specialty of agent, seller selling urgency level, agent feedback rating, property type specialty of agent, agent bio including college education, work history, military, geographic working and living history, agent multiple language fluency, agent license history, and other related items. Thus the end result is confirmation of the agents 60 claims to specific expertise areas based on reviews of the seller 55 customers.

Further, optionally for the seller and agent collaboration system 50, the instructions 150 for producing a matching algorithm 155 as between the seller 55 profile database account 80 and the agent pool 115 being the plurality of single agent 60 database accounts 120, the matching algorithm 155 can include a priority rank ordering of the seller 55 and agent 60 outside or external social media connections that are previously existing. Thus, if the seller 55 and agent 60 are already linked either directly or indirectly through outside or external social media website(s), this can elevate that particular agent 60 within the plurality 185 of agents 60 matched with the seller 55 in the output 180 to rank closer toward the first closest agent 60 match.
Incorporation by reference to the specification for the source code as follows:
Source code—concurrently submitted as ASCII text files;
Files description: Source code for the novel code of the patent application. Note source code is not submitted for “xib” files that are the “story board' of the application nor are DS_Store files submitted that are the icons and backgrounds of the screen displays.
LOGIN FILES FOLLOW:
File name: MyLoginViewControllerhASCII
File size (KB): 1.0
File creation date: May 6, 2014
Author: Alex Levy
File name: MyLoginViewControllermASCII
File size (KB): 5.0
File creation date: May 6, 2014
Author: Alex Levy
File name: MySignUpViewControllerhASCII
File size (KB): 1.0
File creation date: May 6, 2014
Author: Alex Levy
File name: MySignUpViewControllermASCII
File size (KB): 5.0
File creation date: May 6, 2014
Author: Alex Levy
File name: SignUpViewControllerhASCII
File size (KB): 1.0
File creation date: May 6, 2014
Author: Alex Levy
File name: SignUpViewControllermASCII
File size (KB): 1.0
File creation date: May 6, 2014
Author: Alex Levy
AGENT FILES FOLLOW:
File name: AgentTableViewCellhASCII
File size (KB): 1.0
File creation date: May 7, 2014
Author: Alex Levy
File name: AgentTableViewCellmASCII
File size (KB): 1.0
File creation date: May 7, 2014
Author: Alex Levy
File name: AgentTableViewControllerhASCII
File size (KB): 1.0
File creation date: May 7, 2014
Author: Alex Levy
File name: AgentTableViewControllermASCII
File size (KB): 6.0
File creation date: May 7, 2014
Author: Alex Levy
File name: ProfileControllerhASCII
File size (KB): 2.0
File creation date: May 7, 2014
Author: Alex Levy
File name: ProfileControllermASCII
File size (KB): 10.0
File creation date: May 31, 2013
Author: Tope
SELLER FILES FOLLOW:
File name: FullView7ControllerhASCII
File size (KB): 2.0
File creation date: April 5, 2014
Author: Alex Levy
File name: FullView7ControllermASCII
File size (KB): 38.0
File creation date: April 5, 2014
Author: Alex Levy
File name: SellerTableViewCellhASCII
File size (KB): 1.0
File creation date: May 7, 2014
Author: Alex Levy
File name: SellerTableViewCellmASCII
File size (KB): 1.0
File creation date: May 7, 2014
Author: Alex Levy
File name: SellerTableViewControllerhASCII
File size (KB): 1.0
File creation date: May 7, 2014
Author: Alex Levy
File name: SellerTableViewControllermASCII
File size (KB): 6.0
File creation date: May 7, 2014
Author: Alex Levy

### CONCLUSION

Accordingly, the present invention of a Seller and Agent Collaboration System and method has been described with some degree of particularity directed to the embodiments of the present invention. It should be appreciated, though; that the present invention is defined by the following claims construed in light of the prior art so modifications or changes may be made to the exemplary embodiments of the present invention without departing from the inventive concepts contained therein.

1. A seller and agent collaboration system for matching a seller with an agent to help consummate a sale of real property, said system comprising:
(a) a credential protected seller data portal for a single seller to gain access to a seller section;
(b) a single seller profile database account created with a non-anonymous seller identification and an anonymous seller identification, said seller profile database account includes an agent criterion that has a plurality of agent parameters, wherein the seller inputs a unique scale item level for each of said plurality of agent parameters in addition to the seller inputting a unique seller selected weight associated with each agent parameter forming said seller section;
(c) a credential protected agent data portal for a single agent to gain access to an agent section;
(d) a plurality of single agent database accounts defined as an agent pool, each single agent profile database account created with a non-anonymous agent identification, said agent profile database account includes an agent criterion that has a plurality of agent parameters, wherein the agent inputs an index value for each of said plurality of agent parameters in addition to the agent inputting a unique agent selected weight associated with each agent parameter forming said agent section;
(e) one or more processors;
(f) memory; and
(g) one or more programs, wherein said one or more programs are stored in said memory and executed by said one or more processors, said one or more programs including; and
(g)(i) instructions for producing a matching algorithm as between said seller profile database account and said agent pool being said plurality of single agent database accounts, said matching algorithm has a priority rank ordering of said seller selected weights associated with each agent parameter that are matched with each of said plurality of unique agent selected weights associated with each agent parameter such that said seller selected parameter weights and said agent selected parameter weights are equally matched in a pair irrelevant to a particular agent criterion parameter of said seller or said agent, further for each said equal weighted pair if said equal weighted pair has identical parameters then a match is sought as between said sellers scale item level and said agent's index value, termed a first category level range, if no match exists then based upon said sellers parameter, a same parameter adjacent scale item level is checked for a match termed a second category level range, and if no match is found, then based upon said sellers parameter, a same parameter next adjacent scale item level is checked for a match termed a third category level range, if no match exists or said equal weight sellers and agent parameters are not the same, iterative instructions are such that sellers next highest weight parameter scale item level is matched to said agent pool to a specific agent whose matching parameter has a highest weight, then a match is sought as between said sellers scale item level and said agent's index value defined as a first category level range, if no match exists then based upon said sellers parameter, a same parameter adjacent scale item level is checked for a match termed a second category level range, and if no match is found, then based upon said sellers parameter, a same parameter next adjacent scale item level is checked for a match termed a third category level range, if no match exists said iterative instructions are repeated;
(g)(ii) instructions for producing an output having a specific agent matched with the seller; and
(g)(iii) instructions for confirming said specific agent being available for the seller, wherein said specific agent indicates a positive response for availability to the seller or a negative response for non-availability to the seller, if a negative response said specific agent is removed from said agent pool relative to said seller and step (g)(i) is repeated.

2. A seller and agent collaboration system according to claim 1 wherein said first, second, and third category level ranges are truncated to said first category level range only when said agent criterion parameter is above a selected amount being selected from the group consisting of a desired real property price level range and a square feet of living area.

3. A seller and agent collaboration system according to claim 1 wherein said instructions for producing an output further include a plurality of agents matched with the seller, wherein said plurality of agents are ranked from a second closest match to the seller to a least closest match to the seller.

4. A seller and agent collaboration system according to claim 1 further including a messaging module to enable a confidential seller communication portal that facilitates an initial anonymous one-way only communication from seller to agent thus blocking communication from the agent to the seller, and subsequent communication as between the seller and agent that is a two-way communication wherein the seller remains anonymous until the seller selectably engages in non-anonymous two-way communication with the agent.

5. A seller and agent collaboration system according to claim 1 further including a seller authentication module that is to certify property related parameters from public records that are from said agent criterion parameters relating to said seller profile database account input, wherein said property related parameters are selected from the group consisting of property type, square feet of living area, property tax history, number of bedrooms, square feet of lot, heating/cooling system, materials of construction, lot legal description, number of bathrooms, age of property, and parking-off street/carport/garage.

6. A seller and agent collaboration system according to claim 1 further including an agent authentication module that is to certify agent related parameters by agent feedback reviews by only sellers who have used that particular individual agent, said individual index values of said agent criterion parameters that are from said individual agent profile database account that are selected from the group consisting of team approach, singular approach, time priority agent, completeness priority agent, number of years' experience as an agent, number of transactions closed by the agent, type of transactions closed by the agent, geographic specialty of agent, seller selling urgency level, agent feedback rating, property type specialty of agent, agent bio including college education, work history, military, geographic working and living history, agent multiple language fluency, and agent license history.

7. A seller and agent collaboration remote access apparatus for matching a seller with an agent to help consummate a sale of real property from a remote program, said apparatus comprising:
(a) a local host interface component;
(b) a remote host server computer;
(c) a data communication structure that facilitates a connection between said local host interface component and said remote host server computer allowing data transfer therebetween;
(d) said local host interface component further comprises:
(d)(i) a local human perceptible interface device having an input from and an output to a seller and an agent;
(d)(ii) a local control module having a data communication construction with said local human perceptible interface device and said remote host server computer for initiating a data interaction from said local human perceptible interface device input to an input of said remote host server computer and an output from said remote host server computer to said local human perceptible interface device output;
(e) said remote host server computer further comprises:
(e)(i) one or more processors;
(e)(ii) memory;
(e)(iii) one or more programs, wherein said one or more programs are stored in said memory and executed by said one or more processors, said one or more programs including;
(e)(iii)(1) instructions for building a credential protected seller data portal for a single seller to gain access to a seller section;
(e)(iii)(2) a single seller profile database account created with a non-anonymous seller identification and an anonymous seller identification, said seller profile database account includes an agent criterion that has a plurality of agent parameters, wherein the seller inputs a unique scale item level for each of said plurality of agent parameters in addition to the seller inputting a unique seller selected weight associated with each agent parameter forming said seller section;
(e)(iii)(3) a credential protected agent data portal for a single agent to gain access to an agent section;
(e)(iii)(4) a plurality of single agent database accounts defined as an agent pool, each single agent profile database account created with a non-anonymous agent identification, said agent profile database account includes an agent criterion that has a plurality of agent parameters, wherein the agent inputs an index value for each of said plurality of agent parameters in addition to the agent inputting a unique agent selected weight associated with each agent parameter forming said agent section;
(e)(iii)(5) instructions for producing a matching algorithm as between said seller profile database account and said agent pool being said plurality of single agent database accounts, said matching algorithm has a priority rank ordering of said seller selected weights associated with each agent parameter that are matched with each of said plurality of unique agent selected weights associated with each agent parameter such that said seller selected parameter weights and said agent selected parameter weights are equally matched in a pair irrelevant to a particular agent criterion parameter of said seller or said agent, further for each said equal weighted pair if said equal weighted pair has identical parameters then a match is sought as between said sellers scale item level and said agent's index value, termed a first category level range, if no match exists then based upon said sellers parameter, a same parameter adjacent scale item level is checked for a match termed a second category level range, and if no match is found, then based upon said sellers parameter, a same parameter next adjacent scale item level is checked for a match termed a third category level range, if no match exists or said equal weight sellers and agent parameters are not the same, iterative instructions are such that sellers next highest weight parameter scale item level is matched to said agent pool to a specific agent whose matching parameter has a highest weight, then a match is sought as between said sellers scale item level and said agent's index value defined as a first category level range, if no match exists then based upon said sellers parameter, a same parameter adjacent scale item level is checked for a match termed a second category level range, and if no match is found, then based upon said sellers parameter, a same parameter next adjacent scale item level is checked for a match termed a third category level range, if no match exists said iterative instructions are repeated; and
(e)(iii)(6) instructions for producing an output having a specific agent matched with the seller.

8. A seller and agent collaboration remote access apparatus according to claim 7 wherein said first, second, and third category level ranges are truncated to said first category level range only when said agent criterion parameter is above a selected amount being selected from the group consisting of a desired real property price level range and a square feet of living area.

9. A seller and agent collaboration remote access apparatus according to claim 7 wherein said instructions for producing an output further include a plurality of agents matched with the seller, wherein said plurality of agents are ranked from a second closest match to the seller to a least closest match to the seller.

10. A seller and agent collaboration remote access apparatus according to claim 7 further including a messaging module to enable a confidential seller communication portal that facilitates an initial anonymous one-way only communication from seller to agent thus blocking communication from the agent to the seller, and subsequent communication as between the seller and agent that is a two-way communication wherein the seller remains anonymous until the seller selectably engages in non-anonymous two-way communication with the agent.

11. A seller and agent collaboration remote access apparatus according to claim 7 further including a seller authentication module that is to certify property related parameters from public records that are from said agent criterion parameters relating to said seller profile database account input, wherein said property related parameters are selected from the group consisting of property type, square feet of living area, property tax history, number of bedrooms, square feet of lot, heating/cooling system, materials of construction, lot legal description, number of bathrooms, age of property, and parking-off street/carport/garage.

12. A seller and agent collaboration remote access apparatus according to claim 7 further including an agent authentication module that is to certify agent related parameters by agent feedback reviews by only sellers who have used that particular individual agent, said individual index values of said agent criterion parameters that are from said individual agent profile database account that are selected from the group consisting of team approach, singular approach, time priority agent, completeness priority agent, number of years' experience as an agent, number of transactions closed by the agent, type of transactions closed by the agent, geographic specialty of agent, seller selling urgency level, agent feedback rating, property type specialty of agent, agent bio including college education, work history, military, geographic working and living history, agent multiple language fluency, and agent license history.

13. A method for matching a seller and an agent to help consummate a sale of real property, said method comprising the steps of:
(a) providing at least one server computer in data communication with a computer network, said server computer includes one or more processors and memory;
(b) providing a human perceptible interface device that is in data communication with said computer network;
(c) programing instructions that are stored in said memory and executed by said one or more processors for;
(c) (i) a credential protected seller data portal for a single seller to gain access to a seller section;
(c) (ii) a single seller profile database account created with a non-anonymous seller identification and an anonymous seller identification, said seller profile database account includes an agent criterion that has a plurality of agent parameters, wherein the seller inputs a unique scale item level for each of said plurality of agent parameters in addition to the seller inputting a unique seller selected weight associated with each agent parameter forming said seller section;
(c) (iii) a credential protected agent data portal for a single agent to gain access to an agent section;
(c) (iv) a plurality of single agent database accounts defined as an agent pool, each single agent profile database account created with a non-anonymous agent identification, said agent profile database account includes an agent criterion that has a plurality of agent parameters, wherein the agent inputs an index value for each of said plurality of agent parameters in addition to the agent inputting a unique agent selected weight associated with each agent parameter forming said agent section;
(c) (v) instructions for producing a matching algorithm as between said seller profile database account and said agent pool being said plurality of single agent database accounts, said matching algorithm has a priority rank ordering of said seller selected weights associated with each agent parameter that are matched with each of said plurality of unique agent selected weights associated with each agent parameter such that said seller selected parameter weights and said agent selected parameter weights are equally matched in a pair irrelevant to a particular agent criterion parameter of said seller or said agent, further for each said equal weighted pair if said equal weighted pair has identical parameters then a match is sought as between said sellers scale item level and said agent's index value, termed a first category level range, if no match exists then based upon said sellers parameter, a same parameter adjacent scale item level is checked for a match termed a second category level range, and if no match is found, then based upon said sellers parameter, a same parameter next adjacent scale item level is checked for a match termed a third category level range, if no match exists or said equal weight sellers and agent parameters are not the same, iterative instructions are such that sellers next highest weight parameter scale item level is matched to said agent pool to a specific agent whose matching parameter has a highest weight, then a match is sought as between said sellers scale item level and said agent's index value defined as a first category level range, if no match exists then based upon said sellers parameter, a same parameter adjacent scale item level is checked for a match termed a second category level range, and if no match is found, then based upon said sellers parameter, a same parameter next adjacent scale item level is checked for a match termed a third category level range, if no match exists said iterative instructions are repeated; and
(c)(vi) instructions for producing an output having a specific agent matched with the seller.

14. A method for matching a seller and an agent according to claim 13 wherein said first, second, and third category level ranges are truncated to said first category level range only when said agent criterion parameter is above a selected amount being selected from the group consisting of a desired real property price level range and a square feet of living area.

15. A method for matching a seller and an agent according to claim 13 wherein said instructions for producing an output further include a plurality of agents matched with the seller, wherein said plurality of agents are ranked from a second closest match to the seller to a least closest match to the seller.

16. A method for matching a seller and an agent according to claim 13 further including a messaging module to enable a confidential seller communication portal that facilitates an initial anonymous one-way only communication from seller to agent thus blocking communication from the agent to the seller, and subsequent communication as between the seller and agent that is a two-way communication wherein the seller remains anonymous until the seller selectably engages in non-anonymous two-way communication with the agent.

17. A method for matching a seller and an agent according to claim 13 further including a seller authentication module that is to certify property related parameters from public records that are from said agent criterion parameters relating to said seller profile database account input, wherein said property related parameters are selected from the group consisting of property type, square feet of living area, property tax history, number of bedrooms, square feet of lot, heating/cooling system, materials of construction, lot legal description, number of bathrooms, age of property, and parking-off street/carport/garage.

18. A method for matching a seller and an agent according to claim 13 further including an agent authentication module that is to certify agent related parameters by agent feedback reviews by only sellers who have used that particular individual agent, said individual index values of said agent criterion parameters that are from said individual agent profile database account that are selected from the group consisting of team approach, singular approach, time priority agent, completeness priority agent, number of years' experience as an agent, number of transactions closed by the agent, type of transactions closed by the agent, geographic specialty of agent, seller selling urgency level, agent feedback rating, property type specialty of agent, agent bio including college education, work history, military, geographic working and living history, agent multiple language fluency, and agent license history.

19. A seller and agent matching computer data signal embodied in a carrier wave for use with a computer for matching a seller and an agent to help consummate a sale of real property, said carrier wave comprising:
(a) programing instructions for;
(a) (i) a credential protected seller data portal for a single seller to gain access to a seller section;
(a) (ii) a single seller profile database account created with a non-anonymous seller identification and an anonymous seller identification, said seller profile database account includes an agent criterion that has a plurality of agent parameters, wherein the seller inputs a unique scale item level for each of said plurality of agent parameters in addition to the seller inputting a unique seller selected weight associated with each agent parameter forming said seller section;
(a) (iii) a credential protected agent data portal for a single agent to gain access to an agent section;
(a) (iv) a plurality of single agent database accounts defined as an agent pool, each single agent profile database account created with a non-anonymous agent identification, said agent profile database account includes an agent criterion that has a plurality of agent parameters, wherein the agent inputs an index value for each of said plurality of agent parameters in addition to the agent inputting a unique agent selected weight associated with each agent parameter forming said agent section;
(a) (v) instructions for producing a matching algorithm as between said seller profile database account and said agent pool being said plurality of single agent database accounts, said matching algorithm has a priority rank ordering of said seller selected weights associated with each agent parameter that are matched with each of said plurality of unique agent selected weights associated with each agent parameter such that said seller selected parameter weights and said agent selected parameter weights are equally matched in a pair irrelevant to a particular agent criterion parameter of said seller or said agent, further for each said equal weighted pair if said equal weighted pair has identical parameters then a match is sought as between said sellers scale item level and said agent's index value, termed a first category level range, if no match exists then based upon said sellers parameter, a same parameter adjacent scale item level is checked for a match termed a second category level range, and if no match is found, then based upon said sellers parameter, a same parameter next adjacent scale item level is checked for a match termed a third category level range, if no match exists or said equal weight sellers and agent parameters are not the same, iterative instructions are such that sellers next highest weight parameter scale item level is matched to said agent pool to a specific agent whose matching parameter has a highest weight, then a match is sought as between said sellers scale item level and said agent's index value defined as a first category level range, if no match exists then based upon said sellers parameter, a same parameter adjacent scale item level is checked for a match termed a second category level range, and if no match is found, then based upon said sellers parameter, a same parameter next adjacent scale item level is checked for a match termed a third category level range, if no match exists said iterative instructions are repeated; and
(a)(vi) instructions for producing an output having a specific agent matched with the seller.

20. A seller and agent matching computer data signal according to claim 19 wherein said matching algorithm priority rank and said first, second, and third category level ranges are overrode by said single seller database account having the seller inputting a selected highest weight associated for an agent criterion parameter of time priority which will output agents in accordance with each of their selected weights for said agent criterion parameter of time priority.
